(19) United States
(12) Patent Application Publication
(10) Pub. No.: US 2023/0349352 A1
(43) Pub. Date: Nov. 2, 2023

(54) FLOATING VESSEL FOR ENERGY HARVESTING

(71) Applicant: OFFSHORE POWER PLANT, YTRE ARNA (NO)

(72) Inventor: Atle LOTHE, YTRE ARNA (NO)

(21) Appl. No.: 18/045,972

(22) PCT Filed: Apr. 13, 2021
(86) PCT No.: PCT/NO2021/050098

§ 371 Date: Oct. 12, 2022

(30) Foreign Application Priority Data
Apr. 15, 2020 (NO) 20200454

(51) Int. Cl. F03B 13/14; F03B 13/22

(52) U.S. Cl. CPC F03B 13/144; F03B 13/22; F05B 2220/706

(57) ABSTRACT

The invention relates to a floating vessel (1) for energy harvesting, comprising:a hull (2), and a wave power plant (10). The wave power plant comprises:an inlet (11) arranged to receive waves of water, said inlet (11) leading to a transport channel (12) arranged with an angle to convey and lift water entering the inlet (11),5said transport channel (12) leading to an elevated basin (13) arranged to receive water, and said basin (13) having an outlet to a turbine (14T) below said basin (13), said turbine (14T) running an electrical generator (14G) for converting the potential energy of the water to electrical energy.

### FIELD OF THE INVENTION

The invention relates to a floating vessel for energy harvesting and a method for harvesting energy.

### BACKGROUND OF THE INVENTION

Providing enough clean renewable energy is one of the biggest challenges for society in the coming decades. As the production of renewable energy increases new challenges arises. Among other things the placement of large wind turbines on land is disputed both near residential areas and where they are placed in rural areas as they by some are considered as visual pollution and to harm for the bird population. Due to this and due to more stable, high wind condition, it is desired to move wind turbines out to a floating vessel at sea.

To harvest wind energy on deep waters, floating wind turbines are needed, but there are challenges. To make the use of floating wind turbine economically viable they need to be large. The size of the floating wind turbines poses challenges with production, installation and maintenance. There is a need for large areas for producing and storing them, installation and maintenance is expensive since large floating cranes often are needed.

Large floating wind turbines have rotor diameter of as much as 150 meters and are getting increasingly bigger. A challenge of such large rotors is that the tip speed of the rotor blades becomes very high, and ends ups limiting the wind turbine in high winds. Above a certain wind speed the wind turbines cannot utilize the full energy potential in the wind.

Another aspect that affects both the economy and the carbon footprint is the amount of material that is needed in a floating generator. Due to the size and the forces they are exposed to, large amounts of steel, fiber reinforced plastics, and concrete are required.

Another way of harvesting renewable energy is to convert wave power to another form of energy. Numerus designs has been tried, but still it has proven hard to find a commercially viable solution for a wave power plant.

It is desirable to get as high-power output as possible from each ton of building material; steel or other sort of material, used in the construction. Due to this, combining floating wind turbines with wave power could be regarded as a possibility to increase the power output from each ton of building materials used for a power plant. The problem is that most known offshore wave power plants are built on the principle that some sort of floating object is oscillated vertically by the waves. A foundation for a floating wind generator on the other hand is designed to move as little as possible in the waves to avoid harmful stress on the components of the wind generator. So, until now it has been proven hard to combine harvesting of wave and wind energy in one floating structure offshore.

Another aspect that increases the cost and reduces the flexibility of both offshore floating windmills / wind generators and wave powerplants is anchoring. To maintain the position of such large installations in areas with harsh weather conditions, anchoring is required. Several large and heavy anchors and long anchor lines are needed. This drastically increases cost and reduces flexibility. On the other hand, to keep the position of such floating power plants using dynamic positioning with motors, will consume so much energy that the net output of energy will be low.

### OBJECTS OF THE PRESENT INVENTION

An object of the invention is to provide a floating vessel for harvesting energy.

Another object of the invention is to provide a floating vessel for harvesting energy that can maintain the vessel’s position relative to the seabed without mooring, and with little energy consumption.

Another object of the invention is to provide a floating vessel for harvesting energy that through the use of sails or wings utilize the energy in the wind to maintain its position relative to the seabed.

Another object of the invention is to provide a floating vessel for harvesting energy that through the use of sails or wings utilize the energy in the wind to maneuver and move.

Yet another objective of the invention is to provide a vessel that can harvest both wind and wave energy.

Yet another object of the invention is to provide a vessel that can both harvest wind and wave energy and at the same time keep its position without mooring lines.

Yet another object is to provide a floating vessel for harvesting energy that can harvest more energy per ton of material used in the vessel, compared to existing floating vessels for harvesting energy.

### SUMMARY OF THE INVENTION

In one aspect the invention provides a floating vessel for energy harvesting. The floating vessel comprises: a hull, and a wave power plant. The wave power plant comprises an inlet in the hull, arranged to receive waves of water. Said inlet leading to a transport channel arranged with an angle to convey and lift water entering the inlet.

Said transport channel leading to an elevated basin arranged to receive water, and said basin having an outlet to a turbine below said basin. Said turbine running an electrical generator for converting the potential energy of the water to electrical energy.

The floating vessel can further comprise shielding means at said inlet for shielding the wave power plant from incoming waves, wherein said means comprises a door arranged to move between an open and a closed position.

The floating vessel can further comprise at least one wave foil mounted on said hull, said wave foil arranged to generate forward thrust from vertical movement relative to the water.

The floating vessel can further comprise at least one rudder.

The floating vessel can further comprise at least one airfoil-shaped body protruding up from the floating vessel and the airfoil is arranged to generate thrust from the wind for propelling the floating vessel.

The airfoil can be a wing or a sail.

In another aspect the invention relates to a method for harvesting energy from waves. The method comprises the steps of:
providing the floating vessel as described, and
directing said inlet towards incoming sea waves for allowing said waves to transport water up via said transport channel to said elevated basin, and leading said water down via said outlet to said turbine to run said electrical generator to convert the potential energy of the water in said basing to electrical energy.

The method can further comprise the step of closing the shielding means comprising a door at said inlet for shielding the wave power plant from incoming waves, comprising closing the door in case of waves exceeding a design range for said power plant.

The method can further comprise to utilizing at least one wave foil on said hull to generate forward thrust from vertical movement of said foil relative to the water.

The method can further comprise the steps of, steering at least one rudder and steering at least one airfoil-shaped body protruding up from the floating vessel to generate thrust from the wind for propelling the floating vessel to orient the vessel to receive waves via the inlet.

The method can further comprise the step of utilizing said thrust for maintaining a position of said floating vessel relative to the seabed.

The method can further comprise the step of orienting the airfoil so that the floating vessel moves towards the waves’ direction for increasing the amount of water entering the inlet.

In another aspect the invention relates to an airfoil for generating thrust and harvesting wind energy. The airfoil comprises:
at least one transverse aperture through the airfoil, said transverse aperture arranged for ducting air from a higher-pressure face to a lower-pressure face of said airfoil, and
a wind turbine comprising a turbine rotor and a generator arranged in each aperture.

The airfoil can further comprise a cover arranged to be extended to cover at least one face of the airfoil to block fully or partly for airflow through the one or more apertures.

The cover can be a sheet of fabric arranged to be displaced on and off to cover and uncover the airfoil.

The cover can comprise sections of solid material arranged to be sled to cover and uncover the airfoil.

### DESCRIPTION OF THE DRAWINGS

Embodiments of the present invention will now be described, by way of example only, with reference to the following drawings wherein:

FIG. 1 shows an embodiment of the invention in principle. The sketch is partly in section to show some of the internal components.

FIG. 2 shows in perspective an embodiment of the invention.

FIG. 3 shows in perspective an embodiment of the invention.

FIG. 4 shows in perspective an embodiment of the invention.

FIG. 5 shows a multirotor wind generator in section.

Reference numbers

| | |
|---|---|
| 1 | Floating vessel |
| 2 | Hull |
| 3 | Bow door |
| 4 | Rudder |
| 5 | Propulsion propeller |
| 10 | Wave power plant |
| 11 | Inlet |
| 12 | Transport channel |
| 13 | Elevated basin |
| 14T | Turbine |
| 14G | Electrical generator |
| 15 | Pipe |
| 20 | Multirotor wind turbine |
| 21 | Airfoil / Wing |
| 22 | Turbine rotor |
| 22G | Generator |
| 23 | Aperture |
| 24 | Leading edge |
| 25 | Trailing edge |
| 26 | Lower-pressure face |
| 27 | Higher-pressure face |
| 28 | Airflow |
| 30 | Wave foil |
| 40 | Power generating propeller |

### DESCRIPTION OF PREFERRED EMBODIMENTS OF THE INVENTION

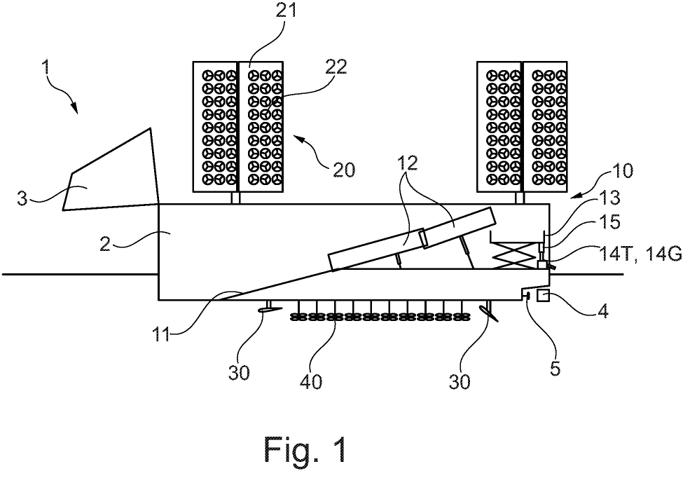

The invention relates to a floating vessel 1 for harvesting energy from wind and waves at sea or other waters such as lakes. The floating vessel 1 comprises in one possible embodiment (see FIG. 1) a wave power plant 10, a multirotor windmill / wind generator 20, wave foil 30 and one or more power generating propellers 40.

The wave power plant 10 comprises in an embodiment an inlet 11, a transport channel 12, an elevated reservoir / basin 13 and a turbine 14T. The wave power plant 10 can further comprise an electrical generator 14G connected to the turbine 14T for generating electrical power.

The multirotor wind generator 20 comprises a number of turbine rotors 22 with generators 22G comprised in an airfoil shaped body 21 such as a wing 21.

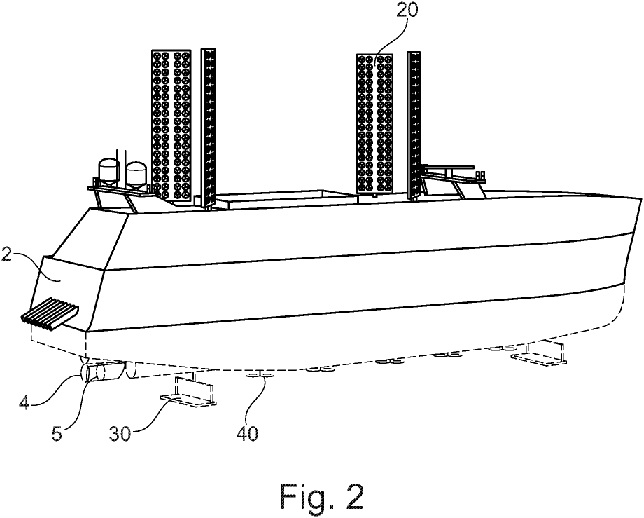

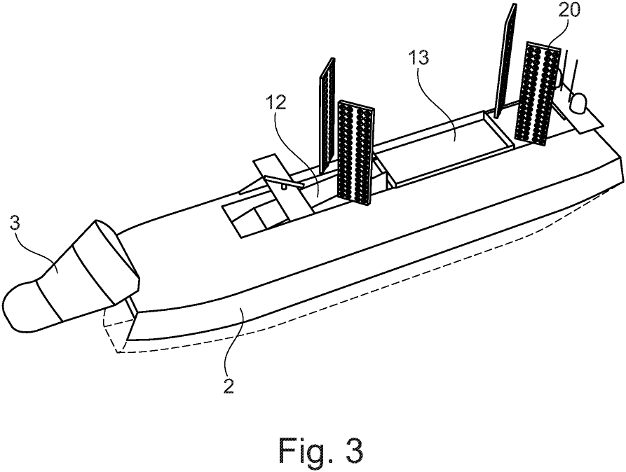

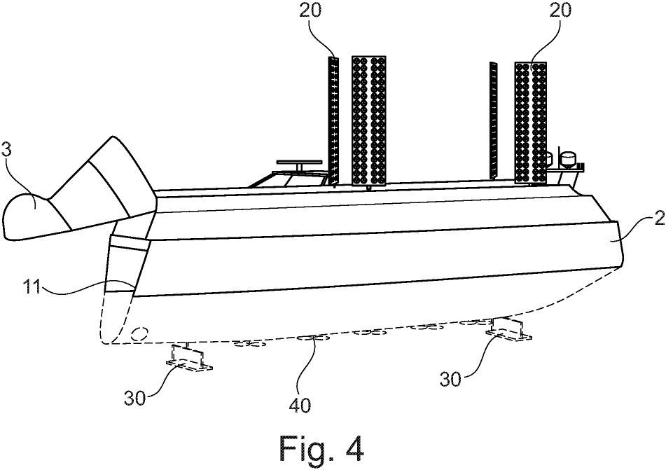

The floating vessel 1 can in an embodiment be shaped similar to a ship as seen in FIGS. 2-4. When the floating vessel 1 is harvesting energy, the bow is directed into the direction of the incoming waves. The floating vessel 1 can have isolation means such as a door preferably a bow port or a bow door 3 which when opens exposes the inlet 11. The means for isolation do not necessarily need to be at the bow (in case the vessel is shaped as a ship as in FIGS. 2-4) as the inlet can be arranged to receive waves from for instance the side of the vessel 1.

The bow door 3 can be arranged to close and isolate the wave power plant 10 from incoming waves when the wave height exceeds the design range of the floating vessel 1 and/or the power plant 10.

With the bow door 3 open the waves will be collected and guided by the inlet 11 into the transport channel 12 which is arranged with an angle, so it lifts water from sea level up and into the elevated reservoir or basin 13. The elevated basin 13 is drained through one or more tubes or pipes 15 down to the turbine 14T connected to a generator (not showed in the figures). The turbine 14T is placed as close to the waterline as possible to give as much head of water above the turbine 14T as possible. The water can be let into the surrounding sea or lake after passing the turbine 14T.

More than one turbine 14T and more than one generator 14G can be used making it possible adjust the capacity of the wave power plant 10. The number of turbines 14T in use at any given time can be adjusted with regards to the amount of water lifted into the elevated basin 13.

To optimize the wave power plant 10 for different wave heights and conditions the height of the elevated basin 13 can be adjusted and likewise the angle of the transport channel 12. The transport channel 12 can in addition be provided with a device for diverting water flowing down the transport channel 12. This is to avoid water from incoming waves to be slowed down by water flowing down the transport channel 12 in the direction of the inlet. In one possible embodiment the device can be a flap in the bottom of the transport channel 12. The flap is laying flat with the bottom of the transport channel 12 when water from a wave is flowing up into the elevated basin 13 and is flipped up with an angle to the bottom of the transport channel 12 when water is flowing down the transport channel 12. The water being diverted can be directed into a turbine to generate power.

The floating vessel 1 can be provided with propellers 40 to utilize the movement of the floating vessel relative to the surrounding body of water for power generation. The propellers 40 can protrude out from the hull 2 into the sea as seen in FIG. 1. The propellers 40 can be retractable into the hull 2 when not in use.

The energy that is collected by the floating vessel 1 can either be stored onboard or transferred via infrastructure that the floating vessel connects to at its location.

In case the energy is stored the energy can as mention be transformed into electrical energy by generators and stored in batteries. Another possibility is to store the energy by utilizing electrical current in an electrolyzer to produce hydrogen that is stored on tanks.

For a floating vessel 1 without mooring lines, with the purpose of harvesting energy to be economical viable it should not rely on supplied energy for positioning or propulsion. The idea is therefor to utilize the forces acting on the floating vessel for positioning and propulsion.

The floating vessel can comprise several means for utilizing the forces of nature acting on the floating vessel 1 for propulsion or for maintain a position relative to the seabed. Such means can be one or more airfoils 21 such as sails or wings 21, one or more wave foils 30 and one or more rudders 4.

In sailing the term “heaving to” or to be “hove to” is referring to a technique used to slow the forward movement of a sailing vessel. When applying this technique, the forces acting on the vessel is set up against each other, so the sum of the forces equals zero or close to zero, leaving the vessel at rest or nearly at rest. In other words, the vessel is “hove to” when the driving action from one or more sails is approximately balanced by the drive from the other(s).

The principle behind the “heaving to” technique can be utilized to maintain the position of a floating vessel 1 for harvesting energy. The floating vessel can be equipped with airfoils 21 that can be used both to maintain position when harvesting energy and to sail the floating vessel 1 when it needs to be moved.

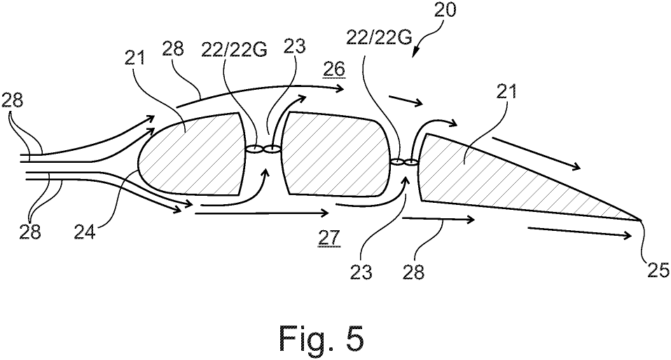

Both sails or wings 21 can be used or even a combination of sails and wings 21. Wings 21 can be stiffer and more rigid structures, and can be similar to an aircraft wing that is arranged vertically protruding up from the top deck of the floating vessel as seen in FIGS. 1-4. The cross section of an airfoil / wing 21 is showed in FIG. 5. The Airfoil 21 in FIG. 5 is provided with internal wind turbines 22, 22G and can be considered as a multirotor wind turbine 20. Such an airfoil 21 do not necessarily need to be provided with wind turbines and apertures 23. Some airfoils 21 on the floating vessel 1 can be just plain airfoils 21 and then some can be equipped with wind turbines 22, 22G. This will, among other things, depend on the area that is needed to generate enough thrust. Airfoils 21 and multirotor wind generators 20 will be discussed more in detail later.

In addition to airfoils 21 wave foils 30 can be utilized for positioning and thrust. The wave foils 30 can be connected to the hull 2 of the floating vessel 1 and will move up and down in the water together with the floating vessel 1.

The principle behind wave foils is known to the person skilled in the art. The floating vessel 1 will move up and down in the water due to the waves and the one or more wave foils 30 will transform some of the up and down movement into forward thrust. The wave foils are shaped so that when they are moved up and down in the water, they generate lift, and the lift has a forward thrust component larger than the drag, thereby creating forward propulsion for the floating vessel 1.

Wave foils 30 also has a desirable effect in addition to the generation of forward trust and that is stabilizing the floating vessel 1. To lift as much water as possible into the elevated basing 13 the floating vessel 1 should plow through the waves as much as possible instead of riding on top of the waves. Wave foils 30 will limit the heave and pitch and thereby more water will go into the inlet 11. At the same time as the wave foils 30 reduces the vertical movement they will generate forward thrust in a direction into the waves. This contributes to maintain the position of the floating vessel 1 and increases the amount of water entering the inlet 11 per time unit. The wave foils 30 can also be adjustable and or rotatable, so that the direction of the trust can be adjusted for the purpose of holding the position of the floating vessel 1, orienting the vessel 1 or for moving the floating vessel 1.

In one possible embodiment the floating vessel 1 maintains its position using a dynamic positioning system that sends control signals to the airfoils 21, rudder 4 and wave foil(s) 30. In addition, the floating vessel 1 can be equipped with a backup propulsion propeller 5 connected to a motor as a backup. The backup propulsion propeller 5 and motor can for instance be used in cases of emergency. The motor can be an electrical motor and can utilized energy that is being stored onboard.

The general principle of a wing/airfoil 21 is that due to the longer distance of travel for the air on one side a pressure difference occurs across the airfoil 21. The same general principle applies to aircraft wings, and sails for sailing and numerus other applications.

FIG. 5 shows in section a possible embodiment of a multirotor wind generator 20 that also can be used for generating trust in a desired direction. The multirotor wind generator 20 comprises an airfoil 21. The airfoil 21 comprises one or more apertures 23 arranged substantially perpendicular on an axis of the airfoil extending from a leading edge 24 to a trailing edge 25 of the airfoil 21. Thereby enabling a flow of air from a higher-pressure face 27 to a lower-pressure face 26 of the airfoil 21. The apertures 23 or channels do not have to be perpendicular to the longitudinal axis of the airfoil 21 or to the axis stretching from the leading edge 24 to the trailing edge 25, but the aperture can be perpendicular to one or both of these axes.

Under the right conditions the speed of the air through the aperture 23 will be greater than the windspeed. An example that substantiates that the wind speed across the airfoil (in the aperture 23) is higher than the general wind speed in the surroundings is the example of a sailboat. A sailboat does not achieve the highest speed of sailing with the wind directly into the sail from behind (running with the wind). A sailing boat reaches higher speed when it utilizes the wing /airfoil principle with the sails (for instance when sailing close-, broad- or beam reach instead of running with the wind.).

In one possible embodiment one or more multirotor generators 20 can be used as sails are used on a sailboat. Each aperture 23 can be equipped with a cover to prevent airflow through the aperture. By opening and closing apertures the trust from the airfoil 21 can be adjusted. The cover can be a sail that can be gradually spread over the airfoil 21 from one side to the other, or it can be a sliding cover that slides in across the aperture 23 or channel. Such a multirotor generator 20 can when the wind is higher than what is needed for trust/propulsion be adjusted to generate less trust/propulsion and harvest more wind energy by adjusting the area of flow between the higher-pressure face 27 and the lower-pressure face 26 across the turbine rotors 22.

There are one significant advantage small turbine rotors 22 have over large rotors on a wind turbines 22, 22G. That advantage is that small rotors are not limited by the tip speed in the same way as large rotors. A large traditional wind turbine that can be as much as 150 meters in diameter will get an enormous tip speed even at low RPMs. Traditional large wind turbines can due to this not utilize high wind condition since the tip speed will damage the tips of the rotor. By using many small rotors to cover a certain area instead of one big rotor to cover the same area high wind conditions can be better utilized for power generation/harvesting, and at the same time the small rotors and generators are less sensitive to movement.

For a floating vessel 1 with the purpose of harvesting renewable energy to be economical viable it needs to harvest as much energy as possible under all condition. During a storm it might not be possible to use the wave powerplant 10. The wave power plant 10 can then be isolated by closing the bow door 3. Even though the bow door 3 is closed to safeguard the floating vessel 1 the multirotor wind generator 20 and the propellers 40 can harvest energy. The multirotor generator 20 is not limited by the tips speed of the rotors, and the propellers 40 will generate more energy due to more vertical movement since the bow door 3 is closed.

The wave foils can help optimize the behavior of the floating vessel to both lift as much water as possible into the elevated basin 13 when the bow door is open and to optimize the power generation from the propellers 40 when the wave power plant 10 is isolated from waves.

The control system sending control signals to among other things the wave power plant, the multirotor generator 20, propellers 40 and the wave foils 30 need to at any given time optimize the floating vessel with regards to safety, positioning and power harvesting.

By the terms energy harvesting and harvesting energy it is meant that energy is converted from one form to another form. Such as energy from wind or waves are converted to an energy form that can be stored or utilized more easily for instance electricity.

In an alternative embodiment a Flettner rotor is used as a wind turbine to harvest wind energy and at the same time the Magnus effect of the Flettner rotor is used for positioning purposes and/or propulsion. A vertical Flettner rotor will produce a component of force perpendicular to the wind direction. This force component can be utilized to maintain the position of the floating vessel 1 or as a contribution to propulsion.

A Flettner rotor can be used instead of or together wings or sails on the previously described floating vessel 1.

1-16. (canceled)

17. A floating vessel (1) for energy harvesting, comprising:
a hull (2),
at least one wave foil (30) mounted on said hull (2), said wave foil (30) arranged to generate forward thrust from vertical movement relative to the water, and
a wave power plant (10) comprising:
an inlet (11) arranged to receive waves of water,
said inlet (11) leading to a transport channel (12) arranged with an angle to convey and lift water entering the inlet (11),
said transport channel (12) leading to an elevated basin (13) arranged to receive water, and
said basin (13) having an outlet to a turbine (14T) below said basin (13),
said turbine (14T) running an electrical generator (14G) for converting the potential energy of the water to electrical energy.

18. The floating vessel (1) according to claim 17, further comprising shielding means (3) at said inlet (11) for shielding the wave power plant (10) from incoming waves, wherein said means comprises a door (3) arranged to move between an open and a closed position.

19. The floating vessel (1) according to any of the preceding claims, further comprising at least one rudder (4).

20. The floating vessel (1) according to any of the preceding claims, further comprising at least one airfoil-shaped body (21) protruding up from the floating vessel (1) and the airfoil (21) is arranged to generate thrust from the wind for propelling the floating vessel (1).

21. The floating vessel (1) according to claim 20, wherein the airfoil (21) is a wing (21) or a sail.

22. A method for harvesting energy from waves, comprising the steps of:
providing the floating vessel (1) according to claim 1,
utilizing the at least one wave foil (30) on said hull (2) to generate forward thrust from vertical movement of said foil (30) relative to the water,
directing said inlet (11) towards incoming sea waves for allowing said waves to transport water up via said transport channel (12) to said elevated basin (13), and
leading said water down via said outlet to said turbine (14T) to run said electrical generator (14G) to convert the potential energy of the water in said basing (13) to electrical energy.

23. The method of claim 22, further comprising closing shielding means (3) comprising a door (3) at said inlet (11) for shielding the wave power plant (10) from incoming waves, comprising closing the door (3) in case of waves exceeding the design range for said power plant (10).

24. The method of claim 22 or 23, further comprising the steps of steering at least one rudder (4) and steering at least one airfoil-shaped body (21) protruding up from the floating vessel (1) to generate thrust from the wind for propelling the floating vessel (1) to orient the vessel (1) to receive waves via the inlet (11).

25. The method of claim 24, further comprising utilizing said thrust for maintaining a position of said floating vessel (1) relative to the seabed.

26. The method of claim 24, wherein the method further comprises orienting the airfoil (21) so that the floating vessel (1) moves towards the waves direction for increasing the amount of water entering the inlet (11).
